(19) United States
(12) Patent Application Publication
(10) Pub. No.: US 2003/0059504 A1
(43) Pub. Date: Mar. 27, 2003

(54) Candy dip it and Lick it

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Melvin L. Crane, 318 South Cleveland Street, Arlington, VA, 22204-2038, US

(21) Appl. No.: 09/961,772

(22) Filed: Sep. 24, 2001

(51) Int. Cl. A23B 4/00

(52) U.S. Cl. 426/115

(57) ABSTRACT

A candy holder that combines two separate types of candy which can be combined by a user in order to provide different tastes. A liquid/gel/paste candy substance is contained in a reservoir housing and a lollipop secured on an end cap can be dipped into the liquid/gel/paste candy substance for enjoyment of a combination of the lollipop and the liquid/gel/paste candy substance.

### BACKGROUND OF THE INVENTION

This invention is directed to a combination of a liquid/gel/paste candy and a hard candy type lollipop which can be dipped into the liquid/gel/paste candy for an enjoyable treat of both candies.

Prior Art

This invention is an improvement over U S. Pat. No. 5,370,884.

Other candy dispensers and candy holding devices have been patented by applicants.

### OBJECTS AND ADVANTAGES OF THE INVENTION

An object of the invention is to provide a delectable candy treat which may be a hard candy or a pressed dextrose candy which can be consumed separately or in combination with a liquid/gel/paste candy by dipping the hard candy into the liquid/gel/paste candy.

Another object is to provide a delectable candy treat in which the candy lollipop and/or the liquid/gel/paste candy are replaceable as desired.

Still another object is to provide a delectable candy treat in which a candy lollipop and/or a liquid/gel/paste candy may be made of the same flavors or a mixture of different flavors.

Other objects and advantages of the invention will become obvious to those skilled in the art upon review of the drawings, specification and claims.

### BRIEF DESCRIPTION OF THE DRAWINGS

FIG. 1 is a side view of the candy holder illustrating a lollipop on a stick; and

FIG. 2 is a side view of a modification in which a hard candy is molded onto the end of a detachable end cap.

### DESCRIPTION OF THE PREFERRED EMBODIMENT

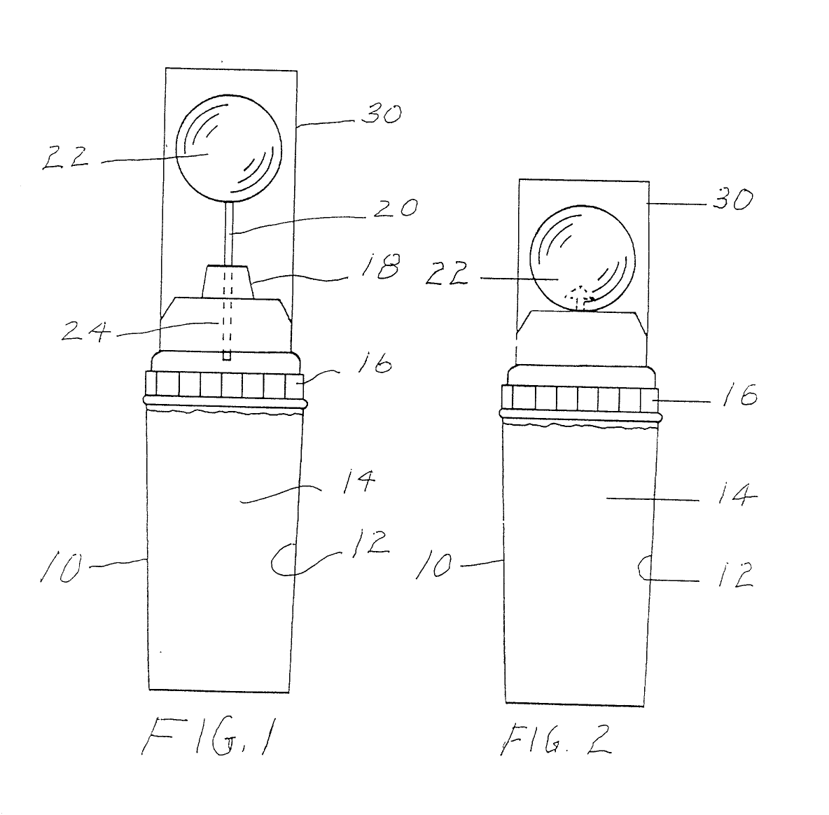

Now referring to the drawings in which the same reference characters represent the same parts throughout the drawings, FIG. 1 illustrates a side view of the device. As shown, the device includes a main housing 10 which forms a reservoir 12 in which a liquid/gel/paste candy substance 14 is placed for consumption. A detachable end cap closure 16 is provided to enclose the housing. The end cap may be screw threaded onto the upper end of the housing or secured by a tight fit without threads. The end cap also provides a holder support 18 for a candy stick 20 on which a lollipop 22 is formed. The holder support includes an aperture 24 in which the candy stick is secured.

FIG. 2 illustrates a modification in which a lollipop 22 is formed directly onto the upper end of the detachable end cap 16. The detachable end cap shown in FIG. 2 can be made with a support means such as a molded nipple upon which said candy may be molded directly without any aperture; or the detachable end cap may be made with an aperture 24 for receipt of a candy stick as shown in FIG. 1 so that after the lollipop 22 is formed on the end of the end cap has been consumed, a lollipop on a stick such as shown in FIG. 1 can be used in the modification shown in FIG. 2. A protective cover 30 may be secured over the candy lollipop and secured to the end a cap as shown in FIGS. 1 and 2.

In use of the device, the housing end and end cap are formed. The end cap may include an aperture 24, as shown. A liquid/gel/paste candy substance 14 is made and placed into the reservoir of the housing. The end cap is placed onto the housing. The end cap may include a lollipop 22 on a stick 20 with one end of the stick secured in the aperture or the end cap may be provided with a lollipop formed onto the end of the end cap. A protective cover may be secured to the upper end of the end cap to protect the candy. When one desires to consume a portion of the lollipop and the liquid/gel/paste candy, the protective cover is removed, the end cap is removed, and the lollipop can be dipped into the liquid/gel/paste candy substance. It would be obvious to one that the lollipop can be consumed without dipping the lollipop into the liquid/gel/paste candy substance or by dipping the lollipop into the liquid/gel/paste candy substance so that the lollipop in combination with the liquid/gel/paste candy can be consumed together. Once sufficient lollipop and/or lollipop and liquid/gel/paste candy substance has been consumed, the end cap may be placed back onto the housing and the protective cover may be replaced to protect the lollipop portion that remains. Obviously, the lollipop on the stick can be removed from the cap for consuming the candy combination and after use, the stick with the remaining lollipop thereon can be replaced on the cap and the cap returned to the housing. The cap could be replaced onto the housing and then the lollipop on the stick can be replaced onto the cap. The cover could then be replaced to protect the candy if so desired. The lollipop on the stick and also the liquid/gel/paste candy can be replenished when it has been consumed.

In the modification shown in FIG. 2, the lollipop can be consumed and subsequent thereto a lollipop on a stick can be secured to the end cap for further pleasure.

The housing may be made of clear plastic so that the liquid/gel/paste candy substance can be seen from the outside. Further, the parts should be made without any sharp ends or parts so that a person will not be injured by the parts.

The foregoing relates to preferred exemplary embodiments of the invention, it being understood that other variants and embodiments thereof are possible within the spirit and scope of the invention, the latter being defined by the appended claims.

We claim:

1. A candy dip it and lick it combination which comprises:
a housing,
a liquid/gel/paste candy substance in said housing,
a detachable end cap on said housing, and
a candy lollipop supported by said end cap.

2. A candy dip it and lick it combination as set forth in claim 1, in which said candy lollipop is molded onto an upper end of said detachable end cap.

3. A candy dip it and lick it combination as set forth in claim 1, in which said end cap includes an aperture therein for mounting a candy lollipop thereon.

4. A candy dip it and lick it combination as set forth in claim 2, in which said end cap may include an aperture therein for mounting a candy lollipop thereon.

5. A candy dip it and lick it combination as set forth in claim 3, in which said aperture in the en cap receives an end of a stick upon which the lollipop is supported.

6. A candy dip it and lick it combination as set forth in claim 1, which includes a cover secured onto said end cap for protecting the candy lollipop supported on the upper end of the detachable end cap.

7. A candy dip it and lick combination as set forth in claim 2, which includes a cover secured onto said end cap for protecting the candy lollipop supported on the upper end of the detachable end cap.

8. A candy dip it and lick it combination as set forth in claim 3, which includes a cover secured onto said end cap for protecting the candy lollipop supported on the upper end of the detachable end cap.

9. A candy dip it and lick it combination as set forth in claim 4, which includes a cover secured onto said end cap for protecting the candy lollipop supported on the upper end of the detachable end cap.

10. A candy dip it and lick it combination as set forth in claim 5, which includes a cover secured onto said end cap for protecting the candy lollipop supported on the upper end of the detachable end cap.

11. A candy dip it and lick it combination as set forth in claim 1, in which said detachable end cap is secured onto said housing with a tight fit.

12. A candy dip it and lick it combination as set forth in claim 2, in which said detachable end cap is secured onto said housing with a tight fit.

13. A candy dip it and lick it combination as set forth in claim 1, in which said detachable end cap is secured onto the upper end of said housing by a securing means such as screw threads or snap locks.

14. A candy dip it and lick it combination as set forth in claim 2, in which said detachable end cap is secured onto the upper end of said housing by a securing means such as screw threads or snap locks.
